(19) United States
(12) Patent Application Publication
(10) Pub. No.: US 2006/0162404 A1
(43) Pub. Date: Jul. 27, 2006

(54) Luggage locking device with an indicating unit

(75) Inventor: Dick-Ming Hsieh, Tainan Hsien (TW)

Correspondence Address: MCNEES, WALLACE & NURICK LLC, 100 PINE STREET, P.O. BOX 1166, HARRISBURG, PA, 17108-1166, US

(73) Assignee: EMINENT LUGGAGE CORP., Tainan Hsien (TW)

(21) Appl. No.: 11/109,418

(22) Filed: Apr. 19, 2005

(30) Foreign Application Priority Data
Jan. 21, 2005 (TW) 94201192

(51) Int. Cl. E05B 65/52; E05B 41/00

(52) U.S. Cl. 70/71; 70/432

(57) ABSTRACT

A locking device includes a seat, a latching unit, an indicating unit, a sliding unit, and a locking unit. The latching unit is formed with a window therethrough. The indicating unit has an indicating portion, and is slidable relative to the latching unit to a locked position, where the indicating portion of the indicating unit is registered with the window in the latching unit. The sliding unit engages the indicating unit, and is slidable relative to the seat to an engaging position, where the sliding unit engages the actuator. The sliding unit drives movement of the indicating unit to the locked position when the sliding unit is moved to the engaging position. The locking unit is operable in a locking mode, where the locking unit drives movement of the sliding unit to the engaging position.

### BACKGROUND OF THE INVENTION

1. Field of the Invention

The invention relates to a locking device for a luggage, more particularly to a luggage locking device that includes a locking unit, and an indicating unit that indicates operating modes of the locking unit.

2. Description of the Related Art

A conventional locking device, which is applied to a luggage, includes a latching unit and a locking unit. The luggage includes first and second luggage halves that are connected pivotally to each other. The first and second luggage halves are pivotable relative to each other between opened and closed positions. The latching unit is mounted on the first luggage half of the luggage, and is operable between a latching position, where the first and second luggage halves of the luggage are retained at the closed position, and an unlatching position, where movement of the first and second luggage halves of the luggage to the opened position is permitted. The locking unit is mounted on the first luggage half of the luggage, and is operable in a locking mode, where the locking unit locks the latching unit at the latching position, and an unlocking mode, where operation of the latching unit to the unlatching position is permitted.

The aforementioned locking device is disadvantageous in that it does not provide an indication as to the current operating mode of the locking unit.

### SUMMARY OF THE INVENTION

Therefore, the object of the present invention is to provide a locking device that is capable of overcoming the aforesaid drawback of the prior art.

According to the present invention, a locking device comprises a seat, a latching unit, an indicating unit, a sliding unit, and a locking unit. The locking device is applied to a luggage, which includes luggage halves that are coupled to each other. The luggage halves are pivotable relative to each other between opened and closed positions. The seat is adapted to be mounted on one of the luggage halves. The latching unit includes an actuator that is coupled pivotally to the seat and that is formed with a window therethrough. The actuator of the latching unit is pivotable relative to the seat from an unlatching position to a latching position, where the actuator is adapted to latch the first luggage half to the second luggage half. The indicating unit includes an indicator that is coupled slidably to the actuator of the latching unit and that has an indicating portion. The indicator of the indicating unit is slidable relative to the actuator of the latching unit from an unlocked position to a locked position, where the indicating portion of the indicator of the indicating unit is registered with the window in the actuator of the latching unit. The sliding unit is disposed slidably in the seat, and has a driving portion that engages the indicator of the indicating unit when the actuator of the latching unit is at the latching position. The sliding unit is slidable relative to the seat from a disengaging position to an engaging position, where the sliding unit engages the actuator. The driving portion of the sliding unit drives movement of the indicator of the indicating unit to the locked position when the sliding unit is moved to the engaging position. The driving portion of the sliding unit drives movement of the indicator of the indicating unit to the unlocked position when the sliding unit is moved to the disengaging position. The locking unit is mounted on the seat, is coupled to the sliding unit, and is operable in a locking mode, where the locking unit drives movement of the sliding unit to the engaging position, and in an unlocking mode, where the locking unit drives movement of the sliding unit to the disengaging position.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a locking device according to the present invention;

FIG. 2 is an exploded perspective view illustrating an actuator of a latching unit, an indicator of an indicating unit, and sliding parts of a sliding unit of the preferred embodiment;

FIG. 3 is a partly sectional view illustrating a locking unit of the preferred embodiment;

FIG. 4 is a schematic view of the preferred embodiment in an assembled state;

FIG. 5 is a partly sectional view of the preferred embodiment to illustrate the actuator of the actuating in an unlatching state; and

FIG. 6 is a partly sectional view of the preferred embodiment to illustrate the actuator of the actuating in a latching state.

### DETAILED DESCRIPTION OF THE PREFERRED EMBODIMENT

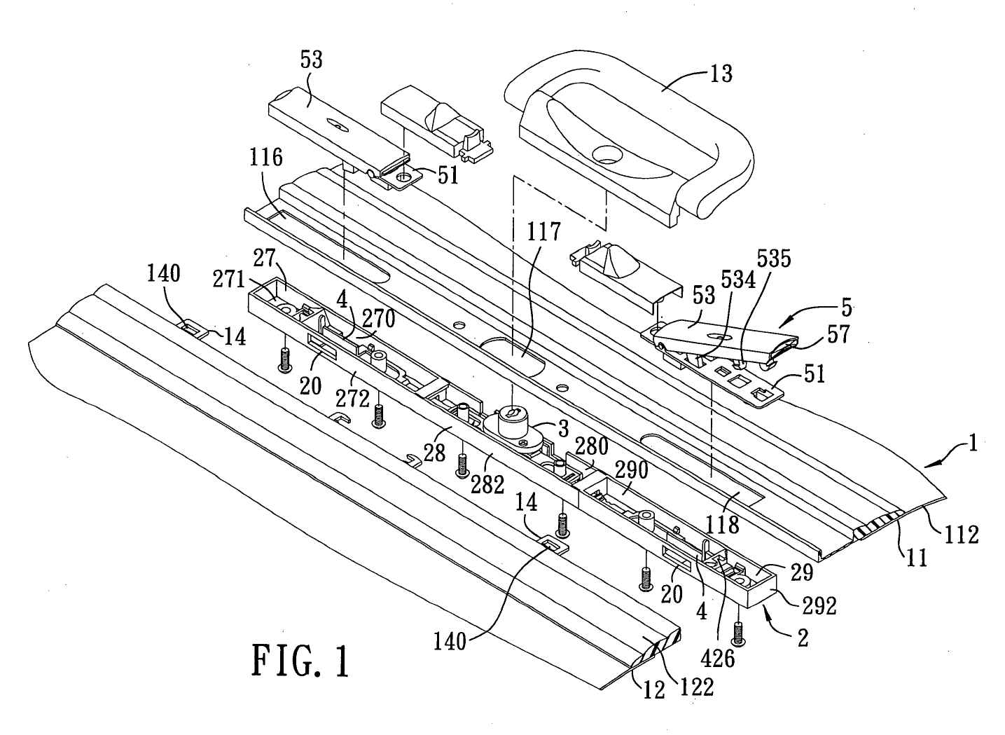

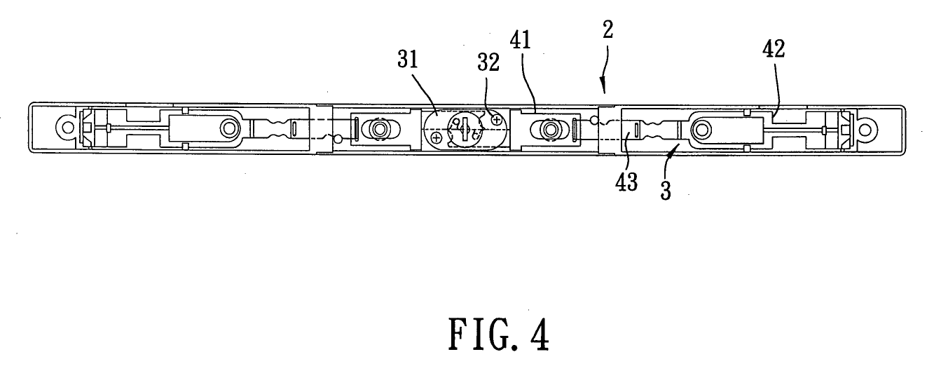

Referring to FIGS. 1 to 4, the preferred embodiment of a locking device according to this invention is shown to include a seat 2, a pair of latching units 5, a pair of indicating units, a pair of sliding units 4, and a locking unit 3.

The locking device of this embodiment is applied to a luggage 1 that includes first and second luggage halves 11, 12, each of which includes a protective wall (not shown), and a surrounding wall 112, 122 that extends from a periphery of the protective wall. The surrounding walls 112, 122 of the first and second luggage halves 11, 12 of the luggage 1 are connected pivotally to each other in a well-known manner. The surrounding wall 112 of the first luggage half 11 of the luggage 1 is formed with a plurality of mounting holes 116, 117, 118 therethrough. The surrounding wall 122 of the second luggage half 12 of the luggage 1 is provided with a pair engaging pieces 14, each of which defines an engaging hole 140. The luggage 1 further includes a luggage handle 13 that is mounted on the surrounding wall 112 of the first luggage half 11 of the luggage 1. The locking device is mounted on the surrounding wall 112 of the first luggage half 11 of the luggage 1 in a manner that will be described hereinafter.

The seat 2 has opposite left and right end portions 27, 29, and an intermediate portion 28 disposed between the left and right end portions 27, 29 of the seat 2. Each of the left and right end portions 27, 29, and the intermediate portion 28 of the seat 2 is substantially rectangular in shape, is aligned with a respective one of the mounting holes 116, 118, 117, and includes a base wall 271, 291, 281, and a surrounding wall 272, 292, 282 that extends from a periphery of the base wall 271, 291, 281. The base and surrounding walls 271, 291, 281, 272, 292, 282 of each of the left and right end portions 27, 29 and the intermediate portion 28 of the seat 2 cooperatively define a mounting space 270, 290, 280.

The surrounding wall 272, 292 of each of the left and right end portions 27, 29 of the seat 2 is formed with an insertion hole 20 therethrough. The first and second luggage halves 112, 122 of the luggage 1 are pivotable relative to each other between an opened position, where each of the engaging pieces 14 is disposed outside of the left and right end portions 27, 29 of the seat 2, and a closed position, where each of the engaging pieces 14 is inserted into the mounting space 270, 290 of a respective one of the left and right end portions 27, 29 of the seat 2 through the insertion hole 20 in the surrounding wall 272, 292 of the respective one of the left and right end portions 27, 29 of the seat 2.

The seat 2 further includes a pair of covers 51, each of which covers the mounting holes 116, 118 in the surrounding wall 112 of the respective one of the left and right end portions 27, 29 of the seat 2 and each of which is formed with first slot 514 therethrough.

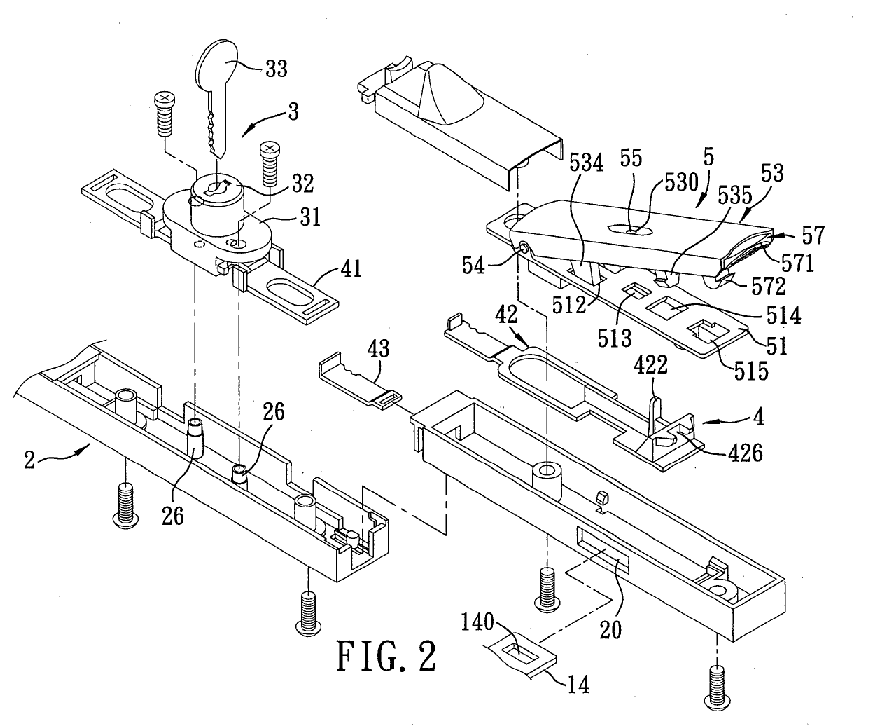

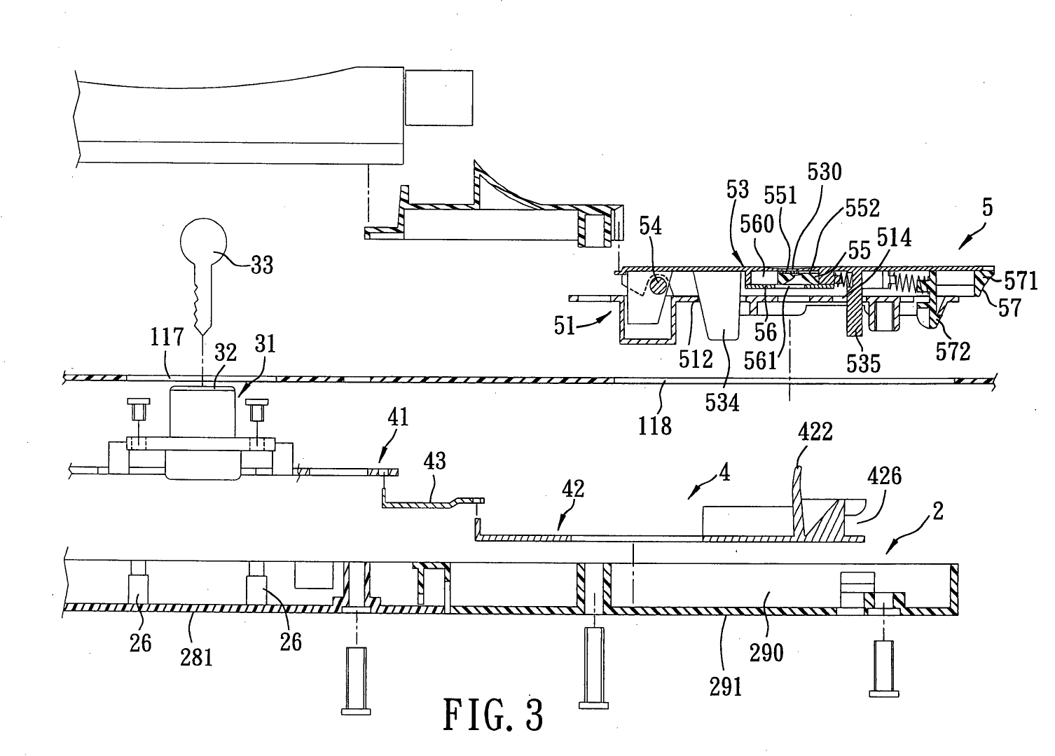

Each of the latching units 5 is disposed on a respective one of the left and right end portions 27, 29 of the seat 2. Since the latching units 5 on the left and right end portions 27, 29 of the seat 2 are identical in construction and operation, only the latching unit 5 on the right end portion 29 of the seat 2 will be described hereinbelow. For clarity, FIGS. 2 and 3 show only the latching unit 5 on the right end portion 29 of the seat 2.

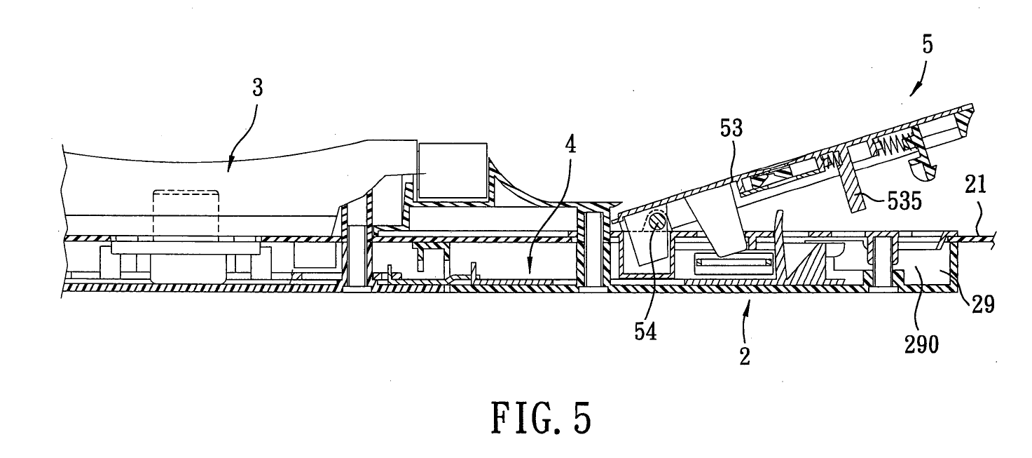

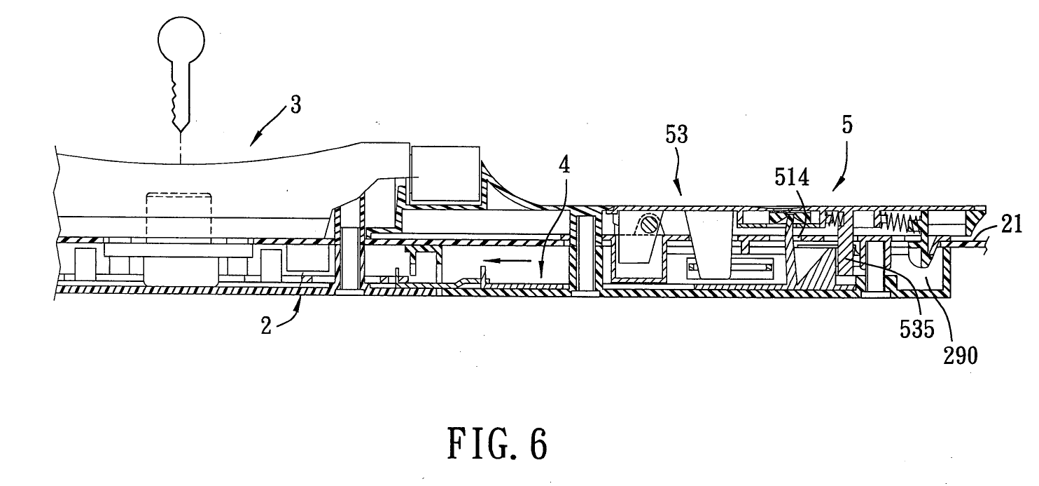

The latching unit 5 includes an actuator 53 that is connected pivotally to the cover 51 of the seat 2 via a pivot joint 54, that is formed with a window 530 therethrough, and that is provided a hook fastener 535. The actuator 53 of the latching unit 5 is pivotable relative to the seat 2 from an unlatching position, where the hook fastener 535 on the actuator 53 is disposed outside of the mounting space 290 of the right end portion 29 of the seat 2, as best shown in FIG. 5, to a latching position, where the hook fastener 535 on the actuator 53 extends into the mounting space 290 of the right end portion 29 of the seat 2 through the first slot 514 in the cover 51 of the seat 2, as best shown in FIG. 6.

The cover 51 of the seat 2 is further formed with a second slot 512. The actuator 53 is further provided with an engaging projection 534 that extends into the mounting space 290 of the right end portion 29 of the seat 2 through the second slot 512 when the actuator 53 is at the latching position. When the first and second luggage halves 112, 122 of the luggage 1 are at the closed position, and when the actuator 53 of the latching unit 5 is at the latching position, the engaging projection 534 on the actuator 53 engages the engaging hole 140 in the engaging piece 14 on the surrounding wall 122 of the second luggage half 12 of the luggage 1, thereby latching the first and second luggage halves 11, 12 of the luggage 1 at the closed position.

The latching unit 5 further includes a retainer 57 that is provided on the actuator 53 for retaining selectively the actuator 53 in the latching position. In particular, the cover 51 of the seat 2 is further formed with a third slot 515 therethrough. The retainer 57 of the latching unit 5 includes a hook 572 and an operating member 571. The hook 572 of the retainer 57 extends into the mounting space 290 of the right end portion 29 of the seat 2 through the third slot 515 in the cover 51 and engages the cover 51 when the actuator 53 is at the latching position so as to retain the actuator 53 at the latching position. The operating member 571 of the retainer 57 is operable so as to disengage the engaging hook 572 of the retainer 57 from the cover 51, thereby permitting movement of the actuator 53 to the unlatching position.

Each of the indicating units is disposed on a respective one of the left and right end portions 27, 29 of the seat 2. Since the indicating units on the left and right end portions 27, 29 of the seat 2 are identical in construction and operation, only the indicating unit on the right end portion 29 of the seat 2 will be described hereinbelow. For clarity, FIGS. 2 and 3 show only the indicating unit on the right end portion 29 of the seat 2.

The indicating unit includes an indicator 55 that is coupled slidably to the actuator 53 of the latching unit 5. In particular, the indicating unit further includes a support member 56 that is connected to the actuator 53 and that cooperates with the actuator 53 to define an indicator space 560. The indicator 55 is disposed slidably in the indicator space 560, and has opposite first and second indicating portions 551, 552. The indicator 55 is movable relative to the actuator 53 from a locked position, where the first indicating portion 551 of the indicator 55 is registered with the window 530 in the actuator 53 of the latching unit 5, to an unlocked position, where the second indicating portion 552 of the indicator 55 is registered with the window 530 in the actuator 53 of the latching unit 5. Preferably, the first and second indicating portions 551, 552 of the indicator 55 are colored red and blue, respectively.

Each of the sliding units 4 is disposed slidably in the seat 2. Since the sliding units 4 are identical in construction and operation, only one of the sliding units 4 will be described. For clarity, FIGS. 2 and 3 show only one of the sliding units 4.

The sliding unit 4 includes first, second, and third sliding parts 41, 42, 43. The first sliding part 41 of the sliding unit 4 is disposed slidably in the mounting space 280 of the intermediate portion 28 of the seat 2. The second sliding part 42 of the sliding unit 4 is disposed slidably in the mounting space 290 of the right end portion 29 of the seat 2. The third sliding part 43 of the sliding unit 4 couples the first sliding part 41 of the sliding unit 4 to the second sliding part 42 of the sliding unit 4. In this embodiment, the second sliding part 42 of the sliding unit 4 has a driving portion 422, and is formed with a fastening groove 426. The support member 56 is formed with an elongated aperture 561. When the actuator 53 is at the latching position, the driving portion 422 of the second sliding part 42 of the sliding unit 4 extends into the indicator space 560 in the support member 56 of the indicating unit through the elongated aperture 561 and engages the indicator 55.

The sliding unit 4 is slidable relative to the seat 2 from an engaging position, where the fastening groove 426 in the second sliding part 42 of the sliding unit 4 engages the hook fastener 535 on the actuator 53 of the latching unit 5, to a disengaging position, where the fastening groove 426 in the second sliding part 42 of the sliding unit 4 disengages the hook fastener 535 on the actuator 53 of the latching unit 5.

The driving portion 422 of the sliding unit 4 drives movement of the indicator 55 of the indicating unit to the locked position when the sliding unit 4 is moved to the engaging position. On the other hand, the driving portion 422 of the sliding unit 4 drives movement of the indicator 55 of the indicating unit to the unlocked position when the sliding unit 4 is moved to the disengaging position.

The locking unit 3 is disposed in the mounting space 280 of the intermediate portion 28 of the seat 2, and includes a cylinder 31 and a lock core 32. The seat 2 further includes a pair of threaded protrusions 26 that are disposed in the mounting space 280 of the intermediate portion 28 of the seat 2 and that extend from the base wall 281 of the intermediate portion 28 of the seat 2. The cylinder 31 of the locking unit 3 is fastened to the threaded protrusions 26 in the intermediate portion 28 of the seat 2 with the use of screws. The lock core 32 of the locking unit 3 is coupled to the first sliding part 41 of the sliding unit 4; and is operable in a locking mode, where the lock core 32 of the locking unit 3 drives movement of the sliding unit 4 to the engaging position, and in an unlocking mode, where the lock core 32 of the locking unit 3 drives movement of the sliding unit 4 to the disengaging position. It is noted that the lock core 32 of the locking unit 3 is operated in the locking and unlocking modes with the use of a key 33, in a known manner.

In operation, when it is desired to lock the luggage 1, the first and second halves 11, 12 of the luggage 1 are first moved to the closed position. Each of the actuators 53 of the latching unit 5 is then moved to the latching position. Thereafter, the lock core 32 of the locking unit 3 is operated in the locking mode. This results in movement of each of the sliding units 4 to the engaging position and movement of each of the indicators 55 of the indicating unit to the locked position. At this time, the first indicating portion 551 of the indicator 55 of the indicating unit is registered with the window 530 in the actuator 53 of the latching unit 5.

On the other hand, when it is desired to unlock the luggage 1, the lock core 32 of the locking unit 3 is first operated in the unlocking mode. This results in movement of each of the sliding units 4 to the disengaging position and movement of each of the indicators 55 of the indicating unit to the unlocked position. At this time, the second indicating portion 551 of the indicator 55 of the indicating unit is registered with the window 530 in the actuator 53 of the latching unit 5.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A locking device for a luggage, the luggage including a pair of luggage halves that are coupled to each other, the luggage halves being pivotable relative to each other between opened and closed positions, said locking device comprising:
a seat adapted to be mounted on one of the luggage halves;
a latching unit including an actuator that is coupled pivotally to said seat and that is formed with a window therethrough, said actuator of said latching unit being pivotable relative to said seat from an unlatching position to a latching position, where said actuator is adapted to latch the luggage halves when the luggage halves are at the closed position;
an indicating unit including an indicator that is coupled slidably to said actuator of said latching unit and that has a first indicating portion, said indicator of said indicating unit being slidable relative to said actuator of said latching unit from an unlocked position to a locked position, where said first indicating portion of said indicator of said indicating unit is registered with said window in said actuator of said latching unit;
a sliding unit disposed slidably in said seat, and having a driving portion that engages said indicator of said indicating unit when said actuator of said latching unit is at the latching position, said sliding unit being slidable relative to said seat from a disengaging position to an engaging position, where said sliding unit engages said actuator, said driving portion of said sliding unit driving movement of said indicator of said indicating unit to the locked position when said sliding unit is moved to the engaging position, said driving portion of said sliding unit driving movement of said indicator of said indicating unit to the unlocked position when said sliding unit is moved to the disengaging position; and
a locking unit mounted on said seat, coupled to said sliding unit, and operable in a locking mode, where said locking unit drives movement of said sliding unit to the engaging position, and in an unlocking mode, where said locking unit drives movement of said sliding unit to the disengaging position.

2. The locking device as claimed in claim 1, wherein said indicator of said indicating unit further has a second indicating portion that is registered with said window in said actuator of said latching unit when said indicator of said indicating unit is moved to the unlocked position.

3. The locking device as claimed in claim 1, wherein said indicating unit further includes a support member that is connected to said actuator of said latching unit, and that cooperates with said actuator of said latching unit to define an indicator space, said indicator of said indicating unit being disposed slidably in said indicator space.

4. A luggage, comprising:
a pair of luggage halves coupled to each other, said luggage halves being pivotable relative to each other between opened and closed positions; and
a locking device including
a seat mounted on one of said luggage halves,
a latching unit including an actuator that is coupled pivotally to said seat and that is formed with a window therethrough, said actuator of said latching unit being pivotable relative to said seat from an unlatching position to the latching position, where said actuator latches said luggage halves when said luggage halves are at the closed position,
an indicating unit including an indicator that is coupled slidably to said actuator of said latching unit, and that has a first indicating portion, said indicator of said indicating unit being slidable relative to said actuator of said latching unit from an unlocked position to a locked position, where said first indicating portion of said indicator is registered with said window in said actuator of said latching unit,
a sliding unit disposed slidably in said seat, and having a driving portion that engages said indicator of said indicating unit when said actuator of said latching unit is at the latching position, said sliding unit being slidable relative to said seat from a disengaging position to an engaging position, where said sliding unit engages said actuator, said driving portion of said sliding unit driving movement of said indicator of said indicating unit to the locked position when said sliding unit is moved to the engaging position, said driving portion of said sliding unit driving movement of said indicator of said indicating unit to the unlocked position when said sliding unit is moved to the disengaging position, and
a locking unit mounted on said seat, coupled to said sliding unit, and operable in a locking mode, where said locking unit drives movement of said sliding unit to the engaging position, and in an unlocking mode, where said locking unit drives movement of said sliding unit to the disengaging position.
